(19) United States
(12) Patent Application Publication
(10) Pub. No.: US 2004/0134965 A1
(43) Pub. Date: Jul. 15, 2004

(54) Processing device for cables or wires

(76) Inventor: Jiri Stepan, Sargans (CH)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/480,749

(22) PCT Filed: Jun. 17, 2002
(86) PCT No.: PCT/IB02/02250

(30) Foreign Application Priority Data
Jun. 15, 2001 (CH) 1129/01

(51) Int. Cl. B23K 37/00

(52) U.S. Cl. 228/1.1; 228/4.5

(57) ABSTRACT

The invention relates to a processing device for cables or wires, which uses at least one unit for displacing a cable or wire (9), or micro-mechanical actuators for displacing a tool (5). This permits thinner cables or wires to be processed and produces a high degree of precision and excellent control.

The invention relates to a processing apparatus for cables or wires. In the context of the invention, processing apparatus is to be understood as meaning an apparatus which

a) makes modifications to the geometrical dimensions of the cables or wires, such as, for example, a cutting apparatus or an insulation stripping apparatus,

b) makes modifications to the surface of the cables or wires, such as, for example, a cable inscribing or marking apparatus,

c) changes the spatial position of the cables or wires in association with apparatuses under a) or b), such as, for example, winding or positioning or transport apparatuses.

In the context of the invention, cables or wires are to be understood as meaning those electrical or optical components which have an elongated structure and are formed for conducting electrical or optical signals. In particular, they include insulated electrical wires or cables and optical waveguides. These are wire-like components which are provided with at least one insulation layer, are capable of conducting current or light from one point to another and can also be used universally for this purpose. On the other hand, the invention expressly does not relate to so-called bonding apparatuses for the bonding (welding) of metal wires to electronics chips. These apparatuses used in chip manufacture belong to such a special generic form of devices that, although in the widest sense they also move wires (for example gold or platinum wires) and weld them or bond them to certain positions on the chip, they are not understood by a person skilled in the art as being cable processing apparatuses. These devices to which the invention does not relate include, for example, apparatuses according to U.S. Pat. No. 6,089,439, in which a wire holder having clamping jaws for holding, positioning and bonding microscopically fine wires in chip manufacture is described. Accordingly, the prior art to be taken into account by a person skilled in the art for the present invention also does not include those documents which are concerned generally with the production of semiconductor modules, such as, for example, EP-A-810636, where a gripping system for semiconductor wafers is described. Furthermore, apparatuses for microtomy, such as, for example, in U.S. Pat. No. 4,377,958, in which an apparatus for the production of microscopic thin films of preparations is described, do not form a subject of the invention and are not part of the prior art to be considered by a person skilled in the art. Furthermore, apparatuses for cutting laminates from brittle material and plastic, as stated, for example, in DE-A-19851353, where ultrasonic oscillations are applied to a cutting tool in order to improve the cutting effect, are not a subject of the invention and are not part of the prior art to be considered by a person skilled in the art.

In the context of its above-mentioned area, however, the invention relates, for example, to cable insulation stripping machines as launched on the market by the Applicant for many years, such as, for example, the device types: MP 252, MP 257, MP 8015, FO 7045 and Powerstrip 9500. These devices are part of the prior art on which the present invention is based. In these devices, computer- or microprocessor-controlled drives are provided which actuate clamping jaws, holding and centring apparatuses and knives so that cables—for example coaxial cables, single-conductor electric cables, optical waveguides or the like—can be stripped and/or cut through in a highly precise manner. The accuracy with which it is possible to operate in the case of these devices arises from the cooperation of good processing accuracy of the mechanical structure of the devices with precise drives, highly accurate controls and optionally precise measuring sensors.

The drives are as a rule electric motors, for example stepping motors, electromagnets and/or pneumatic drives, frequently connected to gears or lever arrangements.

Since there are limits both in the case of the accuracy of processing and in the case of the quality of the drives used to date, a first object of the present invention was to increase the accuracy of operation of such insulation stripping apparatuses. As a further object, it was intended to find a way of taking into account the trend towards increasingly small and increasingly thin cables, for example for mobile telephony, but also in space flight, etc., and for providing an apparatus for the processing of particularly thin cables which permits high-precision cable processing without causing damage to selected layers of the cable.

Within the above-mentioned scope, the invention furthermore relates, for example, to the cleaving of an optical waveguide. In this context, the following prior art is relevant for a person skilled in the art:

i) U.S. Pat. No. 4,790,465 (1988), which proposes subjecting an optical waveguide to tensile stress by means of a laterally applied knife for better cleaving of said optical waveguide, the knife being subjected to a vibration frequency of, for example, 70 kHz in the feed direction, in addition to its sidewards feed produced by means of a pressure spring. As a result of the frequency, the blade experiences a microscopically fine rhythmic longitudinal displacement in the range of 0.5 μm-1.5 μm between the frequency peak amplitudes. The frequency or the vibration of the knife is generated by means of a piezoelectric crystal.

Starting from such a design, it is the further object of the invention to make the feed for a knife for cleaving, but also for all other processing operations on a cable or wire, better and more directly controllable than is possible by means of a spring or by means of the other above-mentioned, known drives. Electronically controlled feed drives are preferable.

ii) DE-A-3622244 (1988) and DE-A-3781945 (1992) disclose an apparatus for cutting glass fibres by means of a pressure wave. A glass fibre is pressed by means of a pressure wave against a laterally applied rigid knife so that the latter cuts the fibre. The pressure wave is generated by an arc discharge or by a piezoelectric sound wave generator.

Starting from such a design, it is the further object of the invention to provide a possibility not only of cutting through an optical waveguide but also of treating its surface and/or of positioning said optical waveguide itself or tools or transport means relative to it, for example of making an incision in its protective layers and removing said layers without damaging the actual glass fibre. In the case of known methods, it is evident that the precision of the fibre feed by the pressure wave need not be particularly great since all that is important is to make the pressures sufficiently high so that the fibre breaks at the point of the knife. A higher pressure would have no substantial adverse effect. However, if this method were to be used for making an incision in a fibre sheath, an unintentionally high pressure or an unsuitable spatial position of the cutting edge relative to the glass fibre would quickly lead to unintentional damage to the fibre.

In further developments of this concept, it is also intended, according to the invention, to be able to apply suitable forces by the treatment of the surface, by means of which forces it is also possible to carry out crimping operations, welding operations, etc.

iii) DE-A-2640501 (1978) is evidently one of the fundamental disclosures in which the frequency-supported cleaving of optical waveguides was described. Here, an optical waveguide is caused to oscillate or is subjected to an oscillation amplitude which causes the fibre to cleave. The proposed frequencies are, for example, 12.5 kHz. The cleavage occurs with or without a protective layer of the optical waveguide. In this prior art, electromagnetic, piezoceramic or magnetostrictive converters are envisaged as oscillation-generating drives.

Starting from this prior art, it is a further object of the invention to provide an apparatus which is not restricted to the use for cleaving optical waveguides but can also be used for copper cables or the like. In contrast to glass fibres which are brittle per se, it is known that copper cables or the like can be less easily cleaved by oscillation frequencies.

In addition, it is known that piezoelectric sensors can be used for measuring the crimping force (crimping force monitoring). However, for the adjustment operations determined on the basis of the measuring operations, manual changes, changes brought about by electric motors or pneumatic changes are carried out. The accuracy and speed achieved are generally sufficient, but it is the object of the invention to provide, also for crimping presses, a faster and more accurate or better adjustable solution for compensating for unevenness. An example carried out was realized in the “PP3” crimping machine from Kirsten AG, by providing a red lamp as a signal for indicating when a crimping force is exceeded.

Summarizing the above-mentioned objects of the invention, the main object is to find a novel drive system for cable processing machines which permits higher precision and is readily controllable and can be used for glass fibre cables, POF cables, electric cables, coaxial cables, data lines and the like.

In addition to cable cutting and insulation stripping apparatuses, this also includes crimping and welding machines or the like and devices for the preparation of cables (e.g. unrolling, labelling and checking, etc.) and devices for the subsequent processing of the cables (e.g. rolling, stacking, bundling, soldering, welding, adhesive bonding, checking, etc.).

These objects are achieved by the use of micromechanical actuators. In the context of the invention, micromechanical actuators are defined as being the following actuators: actuators which perform extension or shrinking procedures according to one of the following principles of operation: pyrotechnical, soundwave, heat, electrochemical, electromagnetic or current- and/or voltage-controlled extension or shrinking procedures. They include at least one energy actuator and at least one electromechanical energy converter.

In the context of the invention, the micromechanical actuators may also have another design apart from the above definition, in this case the stroke per actuator element (without any translation) being by definition not more than 1 mm.

Nonmicromechanical actuators, such as, for example, electromagnetic, pneumatic or hydraulic actuators or actuators operated by electric motors, are ruled out from the invention unless they are used in combination with micromechanical actuators according to the above definitions (e.g. DC servo stepping motors, synchronous, asynchronous, solenoid, compressed air, hydraulic piston, turbine or fluid power motors or the like).

In the context of use, for example, the following actuators or motors are therefore suitable: ultrasonic motor, ultrasonic ring motor, monomodal ultrasonic motor (oscillating), bimodal ultrasonic motor (oscillating in two planes), bimetal, piezoelectric and/or inch-worm motors, monolithic multilayer, charge-controlled, electrorheological, thermorheological and/or electrostrictive or magnetostrictive actuators, parallel bimorphous converters, thermal expansion and voltage- or current-extension actuators, electrochemical, magnetorheological actuators, actuators comprising shape memory materials, chemomechanical actuators, thermopneumatic, electrostatic and microtechnical actuators (produced by microsystem technology) or the like, an average person skilled in the art understanding these as also including so-called voice-coil actuators.

The context of the invention also includes combinations of at least two of the above-mentioned micromechanical actuators.

Furthermore, the invention also includes combinations of conventional mechanical, pneumatic, hydraulic or electromechanical drives with the micromechanical actuators, which latter, according to the invention, are used for compensating errors of the conventional drives and/or for pure additional driving.

They also include combinations of actuators arranged or used according to the invention with one another.

The following is achieved by the invention:

High feed precision both of the cables and of the wires as well as of the respective processing, positioning and fixing tools, even in the μm range, better processing possibility for very small or very thin cables and wires, simplification for the mechanical system in insulation stripping machines; excellent controllability and repeatability, good regulatability in most actuator types; avoidance of mechanical chains and better reproducibility, very small dimensions of the drives and, depending on the chosen subgroup of the micromechanical actuators used according to the invention, application of very high force and short reaction time, large acceleration and adjusting speed.

By avoiding mechanical chains or by means of the particular properties of certain micromechanical actuators—e.g. piezoelectric actuators—improved rigidity also results.

Furthermore, the invention permits for the first time insulation stripping machines without pneumatic, hydraulic or electric motor-driven (in the conventional sense), remote-controllable drives.

Moreover, the actuators used, in particular from the area of piezoelectric technology, offer the possibility of use also as a measuring element simultaneously with driving. The basic principles of the measuring technology using piezoelectric systems are known to a person skilled in the art in the area of measuring apparatuses, so that there is no need to discuss them in more detail here. This applies to individual piezoelectric systems and to piezoelectric cascades in which a plurality of piezoelectric systems are connected in series. It is also possible to use piezoelectric cascades arranged in parallel or individual piezoelectric systems (one as a force system and one as a measuring system).

If the actuators used are optionally also employed as sensors, it is possible thereby not only to improve qualitative cable insulation stripping operations, such as, for example, the force-controlled incision into a cable layer, but also to detect the presence of cables or the like in a simple manner. In certain circumstances, this saves additional light barriers or the like. This also permits, for example, observation of the processing procedure in a model (for example on a monitor by means of a graphic or the like).

Processing, positioning and fixing tools are understood as meaning in particular: clamping and transport jaws; rollers and belts; knives of all types, laser or ultrasonic cutting or welding apparatuses (i.e. apparatuses which generate electromagnetic or mechanical waves for cable processing); crimping tools; pressure tools; rollers, belts or the like for cable transport; centring mechanisms; grippers; positioners, labelling and measuring units, etc.

By means of the micromechanical actuators used according to the invention, it is intended to permit not only effects relative to the cable to be processed but also movements of the cable itself during corresponding use. Further information can in principle be dispensed with since all directions of movement, such as along the cable axis, around the cable axis, transversely or obliquely thereto, as have already optionally been provided to date, are now also possible, but substantially more accurately and precisely than to date.

Preferred actuators are formed compatible with microelectronics so that they are compatible, for example, with TTL output, CMOS arrangements, etc. having standardized electrical interfaces.

The invention is therefore a milestone in the further development of cable processing devices.

In terms of design, a multiplicity of the above-mentioned actuators also serves, if required, as a sensor, so that not only driving but also the positioning and/or force determination, acceleration and geometry and other physical properties in the precision range are facilitated.

Specific solutions for drives having an end zone larger than 1 mm can be achieved by the combination of the micromechanical actuators with gears, lever transmissions or the like. As is known per se, force-displacement, displacement-displacement or force-force transmissions can be achieved thereby.

In the context of the invention, for example, the following components or objects known per se can be operated by the micromechanical actuators according to the invention: knives, centring units, guides, clamping units, triggers, for example for cable detection, measuring or calibration units for cable data, process data (diameters, positions, labels or the like). According to the invention, the use of the actuators is therefore also intended in particular in the case of jaws, in the case of rollers and belts, especially for the displacement and rotation thereof (for clamping and possibly also for stripping and for cable transport), in the case of crimping, in the case of printing, in the case of control or positioning of rollers, belts (cable transport), in the case of positioning of centring means, guides, grippers, etc.

In the context of the present invention, knives are to be understood as meaning conventional insulation stripping knives as well as electromagnetic or mechanical waves which can be used for cutting, such as, for example, laser beams or ultrasound or deflecting mirrors thereof and the like, crimping tools or labelling tools. The conventional knives are independent of the drive according to the invention with respect to their shape; thus, conventional dies, V-knives (primarily for nonrotary insulation stripping or cutting processes) or any other desired knife shapes, in particular also for rotational incision, can be used.

From the three-dimensional point of view, and depending on design and use, the stated micromechanical actuators permit movements perpendicular to the cable or wire axis or obliquely thereto, movements along the cable or wire axis or movements of the cable along the cable axis or obliquely or parallel thereto, rotational movements or changes in the geometry of the cables or wires or of the processing tools therefor.

For most actuators, the use, according to the invention, of micromechanical actuators for cable processing machines has, as a further advantage, the possibility of direct feedback control, by using the actuators simultaneously as sensors. According to the invention, combinations of piezoelectric sensors and piezoelectric actuators can of course also be provided, but integrated structures are preferred.

Low-voltage technologies are of course preferably used for controlling the actuators. On the basis of a knowledge of the invention, a person skilled in the art chooses the systems also with regard to aging and cost aspects and availability aspects.

In the text of this Application, the word “micromechanical” means that the mechanical movement takes place in a small region and is to be regarded as being in contrast to “microtechnical”, by which actuators produced by microtechnical methods—e.g. on or in silicon—are meant.

In the context of the invention, “slip rings” are also to be understood as meaning contactless transmission systems, such as, for example, inductive or capacitive power transmitters, feedback regulation optionally being used.

This fundamental concept of the invention includes various embodiments and further developments of these embodiments, as stated or protected in the dependent claims and evident to a person skilled in the art on the basis of the information, if necessary taking into account the teachings of the Patent Applications of the same date which are mentioned below. In this respect, reference is made to the following literature references from the prior art, which provide details of said actuators and the control thereof, etc. for a person skilled in the art:

ISBN 3-540-54707-X Springer Verlag: “Aktoren: Grundlagen und Anwendungen” [Actuators: Basic principles and applications]/Hartmut Janocha;

ISBN 3-8169-1589-2 Expert Verlag: “Technischer Einsatz neuerAktoren” [Technical use of new actuators]/Daniel J. Jendritza et al.

Brochure from the company FRIWO/Duisburg: “ElektrochemischerAktor” [Electrochemical actuator from 02/98;

Company brochure STCO 4300 from 11/94 of the company Stettner GmbH & Co./Neumark/Opf/Germany: “Electronic Components”;

Company brochure of Dr. Lutz Pickelmann Optik/Munich: Piezomechanische Steliglieder und Anwendungen [Piezomechanical actuators and applications], March 1987.

Various embodiments of the invention are discussed in more detail by way of example on the basis of diagrams. The figures show the following:

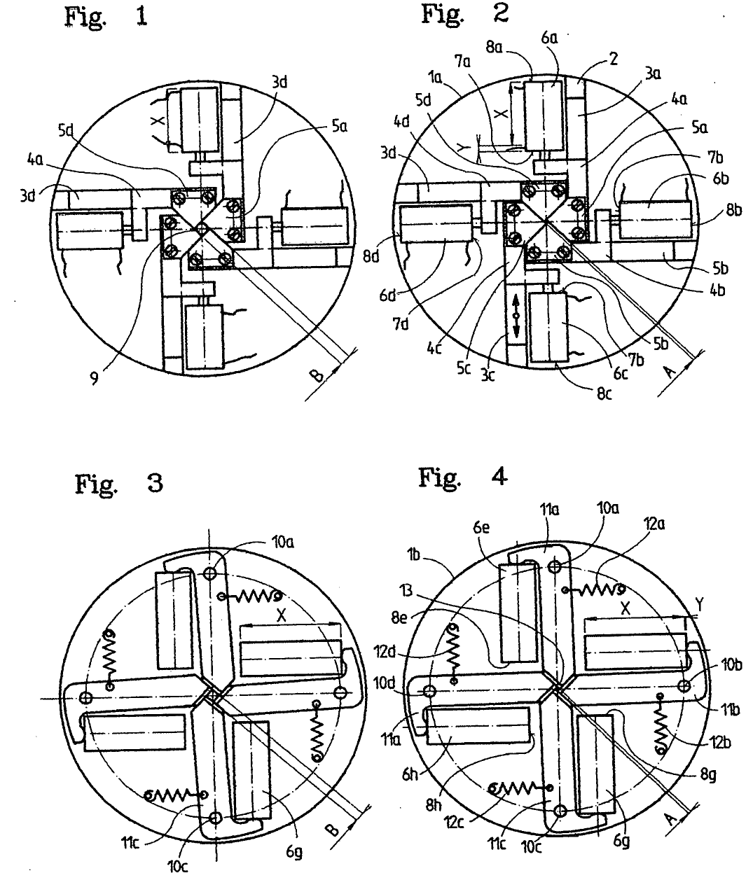

FIG. 1—an end view of an insulation stripping head with insulation stripping knives opened to the diameter B;

FIG. 2—an end view of the insulation stripping head according to FIG. 1 with insulation stripping knives closed to the diameter A;

FIG. 3—an end view of a modified insulation stripping head comprising pivotable knives with knives opened to the diameter B;

FIG. 4—an end view of the insulation striping head according to FIG. 3 with knives closed to the diameter A;

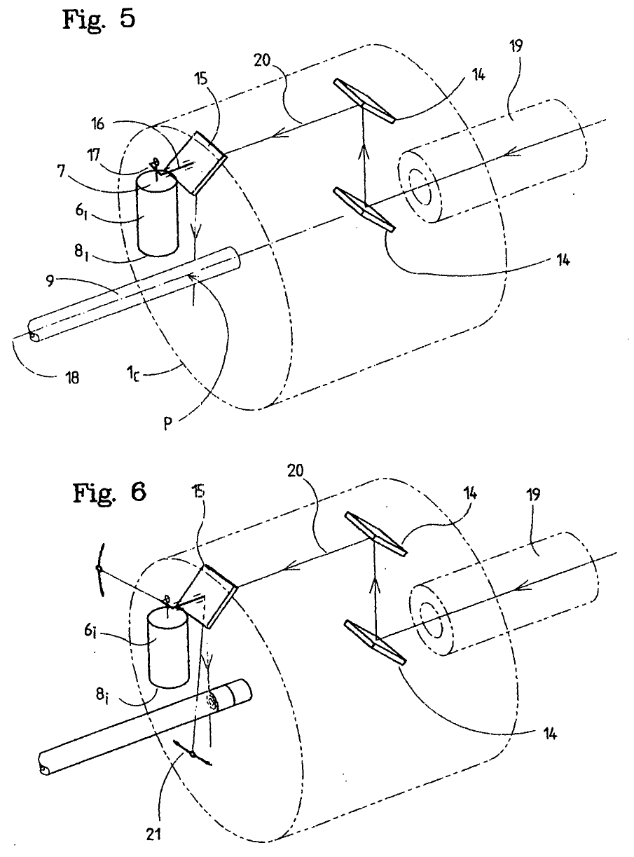

FIG. 5—an oblique view of a diagram of an insulation stripping head comprising a rotatable and controlled mirror arrangement for a laser beam;

FIG. 6—the oblique view according to FIG. 5 with a cable already cut into;

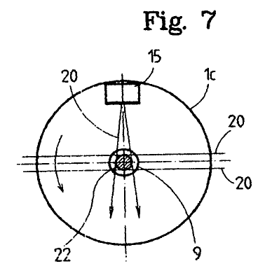

FIG. 7—the end view of a cable sheath cut into by means of the apparatus according to FIG. 5 and, schematically, the cut adjacent to the core;

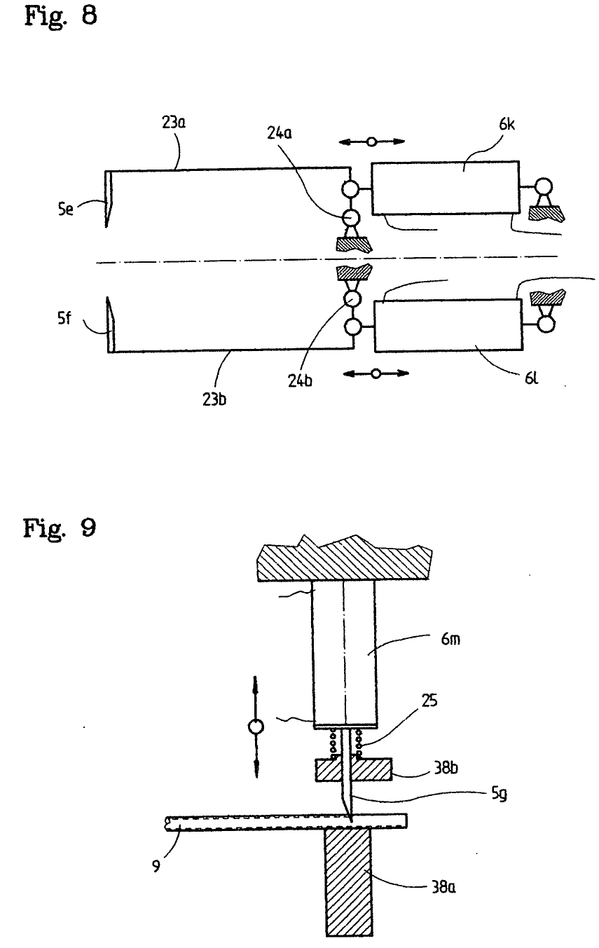

FIG. 8—a side view of a diagram of a lever-controlled insulation stripping head for rotational or nonrotational insulation stripping;

FIG. 9—a view of a schematic insulation stripping or cutting knife which can be brought into the cutting or insulation stripping position by means of a piezomechanical actuator;

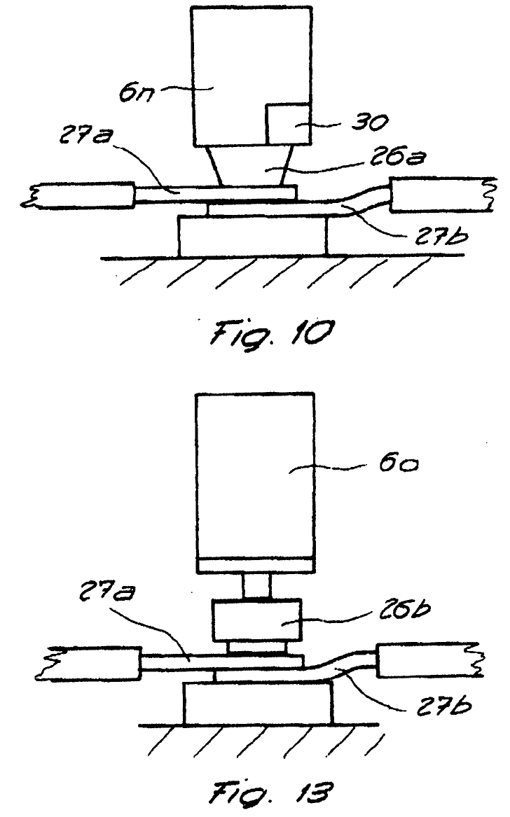

FIG. 10—a structure for connecting cable ends by means of an ultrasonic welding device and a measuring sensor;

FIG. 11—a structure comprising conventional press drive and additional actuator;

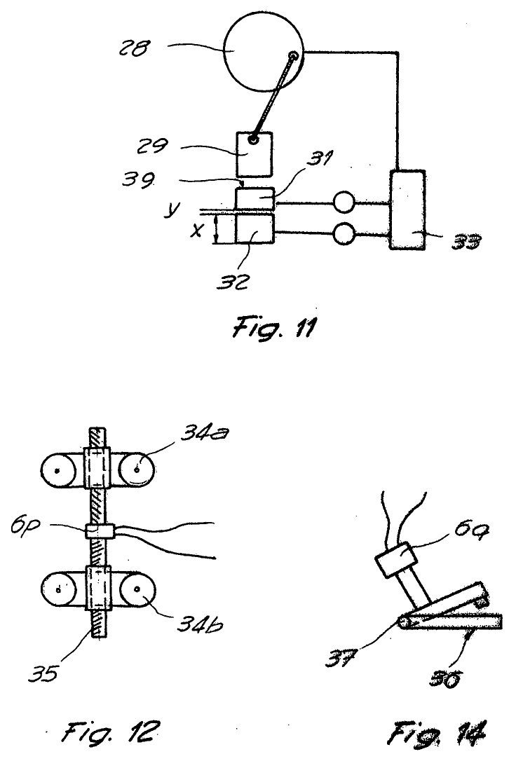

FIG. 12—a conventional double spindle control for drive rollers and clamping rollers with an additional actuator;

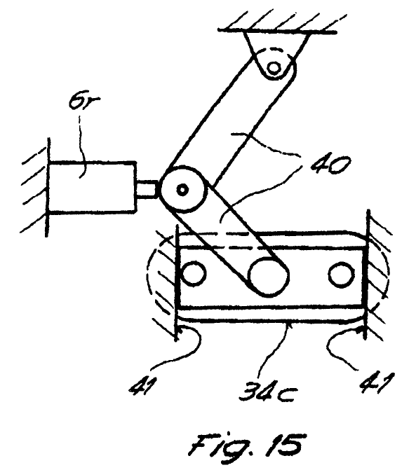

FIG. 13—a variant of FIG. 10 comprising an ultrasonic or resistance welding head without measuring sensor and an actuator;

FIG. 14—a cutting or clamping pliers structure with actuator drive and

FIG. 15—a structure with toggle lever support for roller or belt feed.

The figures are described in relation to one another, identical reference numerals denote identical components, and reference numerals with the same numbers but different indices denote slightly different components which perform the same tasks or have similar effects.

FIG. 1 and FIG. 2 show a structure comprising four knives 5a-d in the opened state with a larger operating opening B and with a reduced operating opening A (e.g. cutting depth). The knives 5a-d correspond to the knives, such as, for example, those in MP 8015 of the Applicant. They can also be understood schematically as being jaws since the present inventive principle can also be applied in the same way to holding or centring jaws.

The knives 5 are held on respective coordinated knife holders 4a-d which can be displaced along one guide bar 3a-d each and thus adjust the magnitude of the operating opening A, B or the cutting or holding depth.

The knife holders 4 are actuated by means of one coordinated micromechanical actuator 6a-d each and are displaced an accurate distance by said actuator. Each actuator 6 is supported with its side 8a-d fixed in the installation stripping head against corresponding receptacles of the insulation stripping head 1, while the other movable side 7a-d of the actuator 6a-d makes contact with the respective knife holders 4a-d and feeds them in the closing direction or withdraws them. X schematically indicates the length of the actuator in the voltage-free state, while Y indicates the difference in length or the feed distance. Preferred actuators for the structure shown are piezoelectric actuators.

The voltage connections shown schematically in the case of the actuator are either connected in parallel or individually actuated, the actuators preferably being supplied simultaneously with the same voltage. Any adjustment of the knives relative to one another can be effected by mechanical compensation or adjustment measures; however, electrical adjustments (via regulated voltage differences) are also possible.

Of course, the invention also relates to structures in which the actuators 6 are used only for support or precision feeding of the knives 5. In the case of these structures, the “side fixed in the installation stripping head” 8 of the actuator 6 is then operated by direct or indirect conventional electromechanical or pneumatic drives (not shown), in order to cover greater distances (feed distances).

Furthermore, as not shown in FIG. 1 and FIG. 2, lever transmissions or the like which increase the efficiency of the actuators are conceivable. One of the possibilities of such a structure comprising lever transmission is shown in FIG. 3, FIG. 4 and 15. In FIG. 3 and 4, a pivot movement to the operating opening A or B is provided instead of a linear movement of the pivotable knives 11a-d. This structure, too, corresponds in its insulation stripping function to the Applicant's structure shown in EP-B-297484 or U.S. Pat. No. 5,010,797 (FIG. 8 and FIG. 9 together with associated sections of the description), so that a discussion of further details of the knives 11a-d or jaws is not necessary here.

In this pivot knife structure, the knives 11a-d are each pivotable about an axis 10-d fixed in the knife head. Since the knives 11a-d are L-shaped, the result is a lever transmission, so that, in the case of small Y distances, feed distances are nevertheless sufficient in the case of the operating opening A, B. Tension springs 12a-d pull the respective knives 11a-d back into their starting position B. Comparable springs can also be provided in the structures according to Fig. [lacuna] and FIG. 2. However, it is also possible in each case for the knife 11 or the knife holder 4 to be firmly connected to the actuator 6 so that the forward movement and backward movement are effected by the actuator without additional spring force.

The insulating stripping apparatuses of FIG. 5 and FIG. 6 comprise a cutting beam feed tube 19 through which a cutting beam 20—for example a laser beam—is directed towards a mirror arrangement 14. The mirror arrangement 14 is followed by a pivotable mirror 15 which is controlled by an actuator 6i. This is anchored with its side 8i fixed in the insulation stripping head to an indicated insulation stripping head 1c and, with its movable side 7e, operates a pivot lever 16 of the pivotable mirror 15 so that the cutting beam can be guided onto a cable 9. Preferably, it is aimed not at the cable axis but to the side thereof, as indicated by the arrow 21. This structure thus results in cut lines, as indicated in FIG. 7, which run past adjacent to the inner conductor 22 and therefore cannot damage the inner conductor 22. On rotation of the insulation stripping head 1c about the cable, the insulation is optimally cut through when the pivotable mirror 15 is correctly actuated.

The structure according to FIG. 8 can also be in the form of a rotational structure or a nonrotational structure. Actuators 6k-l each operate a knife lever 23a-b which, with its knives 5e,f, can be brought into a cutting position on the basis of a pivot axis 24a-b each.

The structure according to FIG. 9 shows an actuator 6m which operates against a pressure spring 25 and is responsible for causing a knife 5g to cut into a cable 9. Stationary abutments 38a,b support, on the one hand, the cable 9 and, on the other hand, the spring 25. 38a could alternatively be a controllable support for moving the cable also relative to the knife. Alternatively, the support 38a could also be replaced by a structure such as 6m, so that incisions can be made from both sides. As another alternative or in combination, 38b could be in the form of a centring means which is pressed towards the cable by the spring 25. Such a structure could also be mounted so as to be rotatable about the cable.

The structure of FIG. 10 and FIG. 13 shows an actuator 6n or 6O, respectively, which operates a welding head 26a or 26b, respectively (e.g. an ultrasonic welding head or resistance welding head) in order to be able to weld two conductor ends 27a and 27b with it. In the context of the invention, the term “welding” includes very generally “joining”, e.g. also “bonding” or the like.

The structure according to FIG. 10 additionally provides a measuring sensor 30 which monitors the correct pressure and optionally controls the contact pressure of the actuator by a regulating means.

FIG. 11 schematically shows a crimping press or the like, in which a drive 28 pushes a ram 29 against a working surface 39, in a cyclic movement. Below the working surface 39 are a measuring sensor 31 and an actuator 32 as a final control element which, in the case of insufficient pressure, increases the latter by virtue of the fact that the actuator 32 travels upwards (Y). The measuring sensor 31 and the final control element 32 and drive 23 are connected in a feedback control loop 33.

FIG. 12 shows a control of the voltage for conveyor belts in an insulation striping machine (e.g. cut and strip machine). As conventionally known, the belts 34a,b are controlled relative to one another via a threaded spindle 35 operating in the opposite direction, as realized, for example, in the machine Powerstrip 9500 of the Applicant. A novel feature in the present structure is that the threaded spindle 35 is divided in the middle and has there an actuator 6p which can move the two spindle halves towards one another or apart in the fine range in order thus to be able to act, in the fine range, on the cable between the belts 34a,b.

FIG. 14 schematically shows a simple insulation stripping pliers 36 whose jaws are pivotable about an axle 37 and are operated by an actuator 6q. Schematically, a chuck may also be present in this representation. The actuator is stationary relative to the axle, this not being shown.

The structure according to FIG. 15 is supported by a toggle lever 40, with the result that on the one hand more force and on the other hand even shorter distances are possible in the positioning of rollers or belts 34c. In the present schematic structure, the rollers are guided in a rail 41 for their closing movement and can thus be fed and opened in the hundredths range.

As a variant, it would also be possible to use drives as described, for example, on pages 255 to 361 of the cited book “Technischer Einsatz neuer Aktoren” [Technical use of new actuators], in particular in FIGS. 8.1, 8.3 and 13.9.

List of Reference Numerals

1—Insulation stripping head (rotary or nonrotary) a;b;c

2—Guide tracks a-d

3—Guide bar a-d

4—Knife holder a-d

5—Cutting knife a-g

6—Micromechanical actuator a-r

7—Movable side of the actuator 6a-e

8—Side of the actuator 6a-i which is fixed in the insulating striping head

9—Cable or wire

10—Axle

11—Pivotable knife

12—Tension spring

13—Knife blade

14—Fixed mirror (mirror arrangement)

15—Pivotable mirror

16—Pivot lever

17—Pivot arm

18—Axis of rotation

19—Cutting beam (e.g. laser) feedable

20—Cutting beam (e.g. laser)

21—Arrow

22—Inner conductor

23—Knife lever a,b

24—Pivot axis a,b

25—Spring

26—Welding head a,b

27—Conductor end

28—Drive

29—Ram

30—Measuring sensor

31—Sensor

32—Final control element

33—Control loop

34—Belt

35—Threaded spindle

36—Insulation stripping pliers

37—Axle

38—Abutment

39—Working surface

40—Toggle lever

41—Rail

Point at which the conductor is held axially relative to the axis of rotation e.g. by means of centring apparatus;

X Length of the actuator without control voltage;

Y Length difference due to applied control voltage

1. Processing apparatus for cables or wires (9), comprising at least one drive (6) for the cables or wires (9), and/or for a holding apparatus for the cables or wires (9), and/or for a tool for processing the cables or wires (9), and/or for tools for fixing parts (plugs) to the cable or wire (9), and/or for joining at least two wires (9, 27), and/or for measuring cable-/wire-specific properties, and/or for measuring process-specific properties, characterized in that the drive comprises at least one micromechanical actuator (6).

2. Processing apparatus according to claim 1, characterized in that at least one drive comprises at least two actuators (6) which are mechanically connected in series.

3. Processing apparatus according to claim 1 or 2, characterized in that the drive comprises at least one actuator (6) or at least two identical or different actuators of the following group: ultrasonic, bimetal, piezoelectric and/or inch-worm motors, monolithic multilayer, charge-controlled, electrorheological, thermorheological and/or electrostrictive or magnetostrictive actuators, parallel bimorphous converters, piezoelectric bending elements (bimorphous), piezoelectric mirror translators (as in space telescope technology), electrochemical, chemomechanical, electrothermal, electrostatic, thermopneumatic or electromechanical (voltage-extending or current-extending), microtechnical actuators, actuators comprising shape memory materials or the like.

4. Processing apparatus according to any of the preceding claims, characterized in that at least one drive comprises a conventional drive (28; 35) from the following group, which acts in combination with at least one micromechanical actuator (6): electro motor-operated, electromagnetic, pneumatic or hydraulic actuators.

5. Processing apparatus according to any of the preceding claims, characterized in that the drive (6) comprises at least one sensor (30) which is preferably formed by the micromechanical actuator itself.

6. Processing apparatus according to any of the preceding claims, characterized in that the micromechanical actuator engages, via a gear and/or via a lever (40) and/or via a converter with a medium, for example hydraulic oil, water, mercury or the like, the components to be moved.

7. Processing apparatus according to any of the preceding claims, characterized in that a control is provided which operates the micromechanical actuator (6) both in the extension and in the shrinkage direction, the control preferably being electrical or electronic.

8. Processing apparatus according to any of the preceding claims, characterized in that the micromechanical actuator (6) is operated by a restoring spring (25).

9. Processing apparatus according to any of the preceding claims, characterized in that the micromechanical actuator (6) is in the form of an actuating member for knives, centring jaws, rollers, belts and grippers or for mirrors (15) of a laser knife (19; 20).

10. Processing apparatus according to any of the preceding claims, characterized in that at least one micromechanical actuator (6) is arranged on a rotatable knife head and can be supplied with voltage via slip rings.

11. Processing apparatus according to any of the preceding claims, characterized in that a control loop (33) with a sensor (30, 31) is coordinated with the actuator (6) and/or that the actuator (6) itself is also used as a sensor.

12. Processing apparatus according to any of the preceding claims, characterized in that, for the actuator (6), both an actuation (open loop) and a regulation (33) (closed loop) are provided for the movement, positioning and/or force application.

13. Processing apparatus according to claim 12, characterized in that the actuation and/or the regulation (33) in the operating state are effected by means of a measuring unit for measuring the actual values at the actuator (6) or at a member to be adjusted by the actuator (6) or at the cable (9) or wire.

14. Use of a micromechanical actuator, in particular of a piezoelectric actuator, for actuating mechanical components in cable insulation stripping machines for positioning these components relative to the cable from which the insulation is to be stripped.

15. Use of a micromechanical actuator, in particular of a piezoelectric actuator, for electronically controlled error correction or for increasing the precision of hydraulic, pneumatic, mechanical or electromechanical drives in or on insulation stripping apparatuses.
